(19) United States
(12) Patent Application Publication
(10) Pub. No.: US 2026/0362255 A1
(43) Pub. Date: Nov. 12, 2026

(54) MULTI-CELL INTERFERENCE MITIGATION FOR POSITIONING REFERENCE SIGNAL (PRS) TRANSMISSION WITH FREQUENCY MODULATED CONTINUOUS WAVE (FMCW)-BASED WAVEFORMS

(71) Applicant: QUALCOMM Incorporated, San Diego, CA (US)

(72) Inventors: Min HUANG, Beijing (CN); Jing DAI, Beijing (CN); Kangqi LIU, San Diego, CA (US); Hao XU, Beijing (CN)

(21) Appl. No.: 19/139,137

(22) PCT Filed: Mar. 9, 2023
(86) PCT No.: PCT/CN2023/080417

§ 371 Date: Jun. 13, 2025

(51) Int. Cl. H04W 36/00; H04W 36/08; H04W 36/30; H04W 56/00

(52) U.S. Cl. CPC H04W 36/0072; H04W 36/08; H04W 36/304; H04W 56/001

(57) ABSTRACT

Disclosed are techniques for wireless communication. In an aspect, a first base station may detect a conflict between a first configuration for a frequency modulated continuous wave (FMCW)-based positioning reference signal (PRS) for the first cell, the first configuration comprising a first time offset for an FMCW-based PRS for the first cell, and a second configuration for an FMCW-based PRS for a second cell, the second configuration comprising a second time offset for an FMCW-based PRS for the second cell. The first base station may modify at least one of the first configuration or the second configuration to resolve the conflict.

### BACKGROUND OF THE DISCLOSURE

### 1. Field of the Disclosure

Aspects of the disclosure relate generally to wireless communication, including wireless positioning.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in positioning reference signal (PRS) processes and technology, and high-density deployments for 5G, enable highly accurate 5G-based positioning.

Sixth generation telecommunication standards, known as “6G”, will include enhancements to support a wide variety of use cases, including mobile broadband, metaverse, massive internet of things (IOT), side-link, massive spectrum aggregation/duplexing, and user equipment (UE) cooperation. Specifically, 6G will include enhanced waveforms and multiaccess design for emerging new technologies such as full duplex, radio frequency (RF) sensing and positioning, physical layer (PHY) security, and others. To do this, 6G waveform and multi-access design should evolve in both existing bands and new bands as RF, duplexing, and multiple-input multiple-output (MIMO) technologies continue to advance. These new waveforms and multi-access designs are intended to support massive connectivity and extremely high cell-capacity, and to efficiently support channel access for a massive number of users.

Some of the waveform design metrics that must be considered for 6G use cases include spectrum efficiency; energy efficiency, for both transmit (Tx) side (e.g., power amplifier (PA) efficiency) and receive (Rx) side (processing power efficiency); waveform processing complexity and latency; RF impairments (error vector magnitude (EVM), etc.); and spectrum confinement for both in-band (IB) and out-of-band (OOB) emissions, with a practical PA model; and support for efficient multi-user/MIMO multiple-access. 6G may impose some requirements against various channel conditions/impairments, such as fading (e.g., time variation, inter-symbol interference (ISI)), phase noise, and PA nonlinearity. To do this 6G may revisit fundamental assumptions about spectrum use and may revisit waveform candidates based on 5G deployment experience.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a first base station of a first cell includes detecting a conflict between a first configuration for a frequency modulated continuous wave (FMCW)-based positioning reference signal (PRS) for the first cell, the first configuration comprising a first time offset for an FMCW-based PRS for the first cell, and a second configuration for an FMCW-based PRS for a second cell, the second configuration comprising a second time offset for an FMCW-based PRS for the second cell; and modifying at least one of the first configuration or the second configuration to resolve the conflict.

In an aspect, a method of wireless communication performed by a source base station of a source cell includes sending, to a target base station of a target cell, a handover request comprising a request for a first configuration for a FMCW-based PRS for the target cell; receiving, from the target base station, the first configuration, the first configuration comprising a first time offset for an FMCW-based PRS for the target cell; and sending the first configuration to a user equipment (UE) served by the source base station.

In an aspect, a method of wireless communication performed by a UE includes receiving, from a serving base station in a source cell, a first configuration for a FMCW-based PRS for a target cell, the first configuration comprising a first time offset for an FMCW-based PRS for the target cell; performing a handover process to handover the UE to the target cell; determining that the first configuration for the target cell conflicts with a configuration for FMCW-based PRS for another cell known to the UE; and sending, to a target base station in the target cell, an indication that the first configuration for the target cell conflicts with a configuration for FMCW-based PRS for another cell known to the UE.

In an aspect, a first base station includes a memory; at least one transceiver; and at least one processor communicatively coupled to the memory and the at least one transceiver, the at least one processor configured to: detect a conflict between a first configuration for a FMCW-based PRS for the first cell, the first configuration comprising a first time offset for an FMCW-based PRS for the first cell, and a second configuration for an FMCW-based PRS for a second cell, the second configuration comprising a second time offset for an FMCW-based PRS for the second cell; and modify at least one of the first configuration or the second configuration to resolve the conflict.

In an aspect, a source base station includes a memory; at least one transceiver; and at least one processor communicatively coupled to the memory and the at least one transceiver, the at least one processor configured to: send, to a target base station of a target cell via the at least one transceiver, a handover request comprising a request for a first configuration for a FMCW-based PRS for the target cell; receive, from the target base station via the at least one transceiver, the first configuration, the first configuration comprising a first time offset for an FMCW-based PRS for the target cell; and send, to a UE served by the source base station via the at least one transceiver, the first configuration.

In an aspect, a UE includes a memory; at least one transceiver; and at least one processor communicatively coupled to the memory and the at least one transceiver, the at least one processor configured to: receive, from a serving base station in a source cell via the at least one transceiver, a first configuration for a FMCW-based PRS for a target cell, the first configuration comprising a first time offset for an FMCW-based PRS for the target cell; perform a handover process to handover the UE to the target cell; determine that the first configuration for the target cell conflicts with a configuration for FMCW-based PRS for another cell known to the UE; and send, to a target base station in the target cell via the at least one transceiver, an indication that the first configuration for the target cell conflicts with a configuration for FMCW-based PRS for another cell known to the UE.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram of example positioning reference signal (PRS) resource repetition and beam sweeping options, according to aspects of the disclosure.

FIG. 6 is a diagram illustrating an example frame structure with a frequency modulated continuous wave (FMCW) chirp, according to aspects of the disclosure.

FIG. 7 is a diagram illustrating in more detail a portion of an example frame structure with an FMCW chirp, according to aspects of the disclosure.

FIG. 8 is a block diagram of an example system that can perform channel estimation, positioning and sensing based on FMCW waveform, according to aspects of the disclosure.

FIG. 9 illustrates a disadvantage of using FMCW waveforms for PRS.

FIG. 10 illustrates a conventional approach to solve the problem illustrated in FIG. 9.

FIG. 11 is a time and frequency graph illustrating one technique for multi-cell interference mitigation for PRS transmission with FMCW-based waveforms, according to aspects of the disclosure.

FIG. 12A and FIG. 12B show example values of signal power measured by a UE across a range of frequencies, according to aspects of the disclosure.

FIG. 13 illustrates an example process, that may be performed by the UE or other receiving entity, associated with multi-cell interference mitigation for PRS transmission with FMCW-based waveforms, according to aspects of the disclosure.

FIG. 14 is a time and frequency graph illustrating another technique for multi-cell interference mitigation for PRS transmission with FMCW-based waveforms, according to aspects of the disclosure.

FIG. 15 is a signaling and event diagram illustrating inter-cell signaling messages associated with multi-cell interference mitigation for PRS transmission with FMCW-based waveforms, according to aspects of the disclosure.

FIG. 16 is a signaling and event diagram illustrating inter-cell signaling messages associated with multi-cell interference mitigation for PRS transmission with FMCW-based waveforms, according to aspects of the disclosure.

FIG. 17 is a flowchart of an example process, performed by a base station, associated with multi-cell interference mitigation for PRS transmission with FMCW-based waveforms, according to aspects of the disclosure.

FIG. 18 is a flowchart of an example process, performed by a base station, associated with multi-cell interference mitigation for PRS transmission with FMCW-based waveforms, according to aspects of the disclosure.

FIG. 19 is a flowchart of an example process, performed by a user equipment (UE), associated with multi-cell interference mitigation for PRS transmission with FMCW-based waveforms, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to multi-cell interference mitigation for positioning reference signal (PRS) transmission with frequency modulated continuous wave (FMCW)-based waveforms. Some aspects more specifically relate to communications between base stations in order to have multiple, partially overlapping FMCW-based PRS signals (herein referred to as “PRS chirps”) occupy the same symbol time, each PRS chirp being transmitted from a different base station, such that the PRS chirps do not interfere with each other. In an aspect, a first base station may detect a conflict between a first configuration for a frequency modulated continuous wave (FMCW)-based positioning reference signal (PRS) for the first cell, the first configuration comprising a first time offset for an FMCW-based PRS for the first cell, and a second configuration for an FMCW-based PRS for a second cell, the second configuration comprising a second time offset for an FMCW-based PRS for the second cell. The first base station may modify at least one of the first configuration or the second configuration to resolve the conflict.

Particular aspects of the subject matter described in this disclosure can be implemented to realize one or more of the following potential advantages. FMCW-based PRS has the benefit of lower Rx baseband processing complexity (including lower ADC sampling rate) than OFDM-based PRS. Proposed partial-overlapping-based FMCW-based PRS has the benefit of lower ADC sampling rate than TDM-based FMCW-based PRS. In some examples, by using the protocols and signaling disclosed herein, the described techniques can be used to enable FMCW-based PRS and mitigate inter-cell interference are herein presented. The disclosed signaling between cells enables FMCW-based PRS while mitigating inter-cell interference, to the benefit of both serving cells and neighboring cells.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IOT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

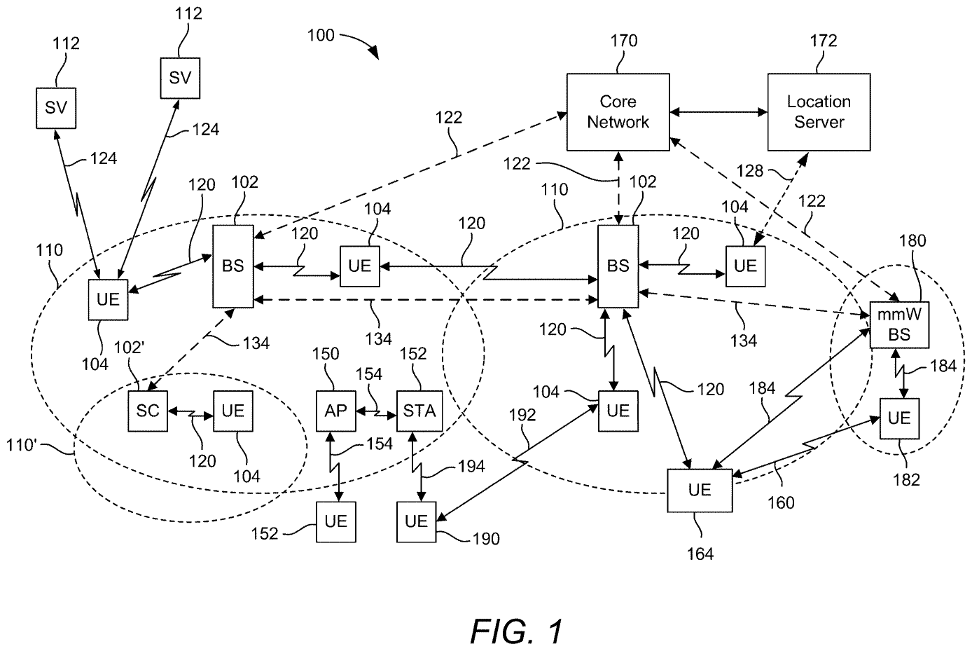

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen-before-talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHZ, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mm W base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

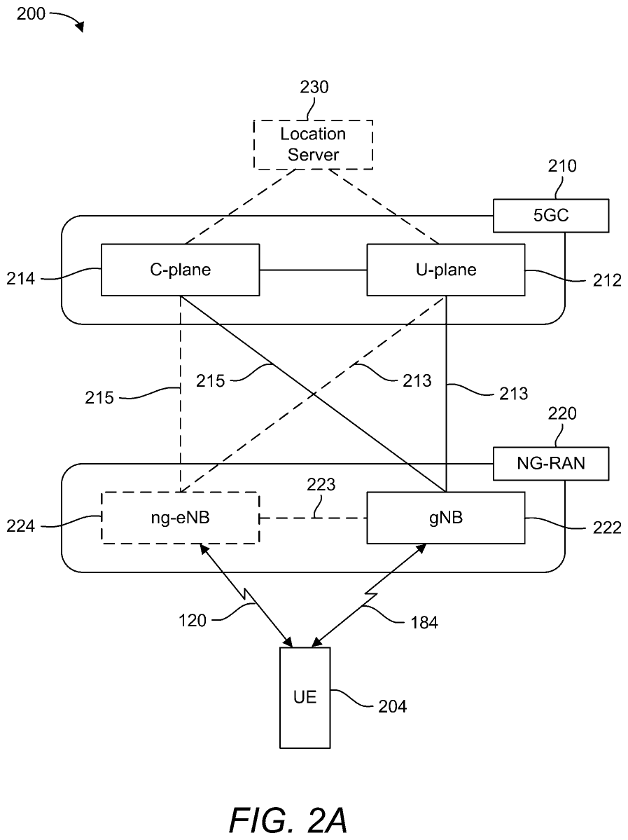

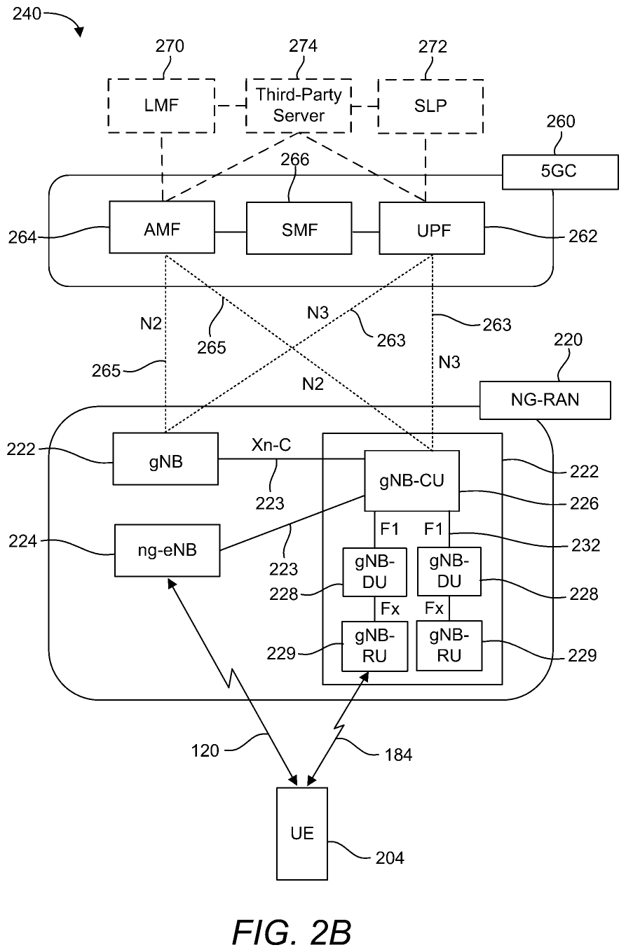

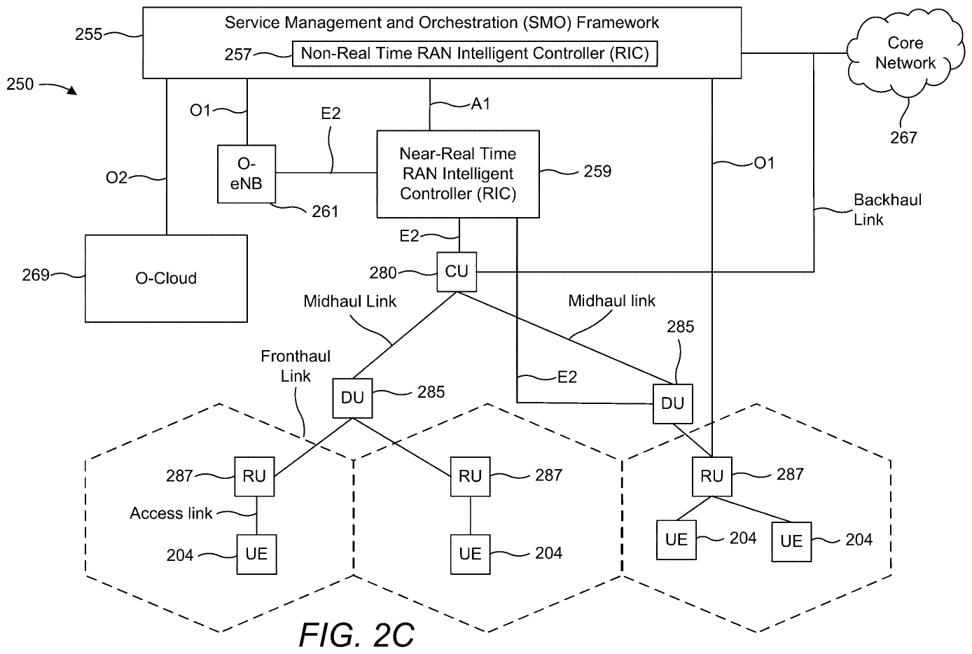

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, access point (AP), a transmit receive point (TRP), or a cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more distributed units (DUs) 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 280 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

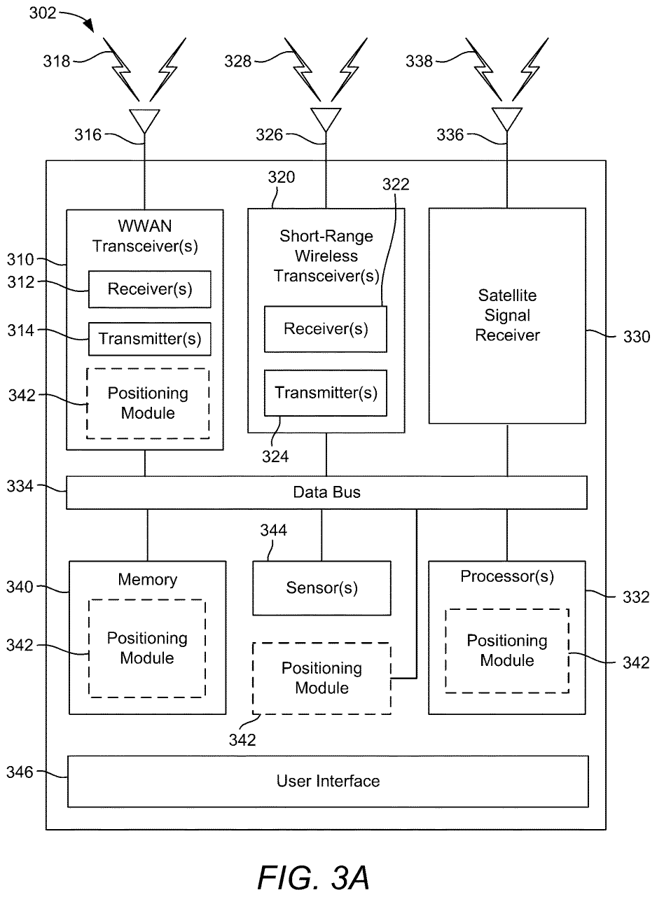

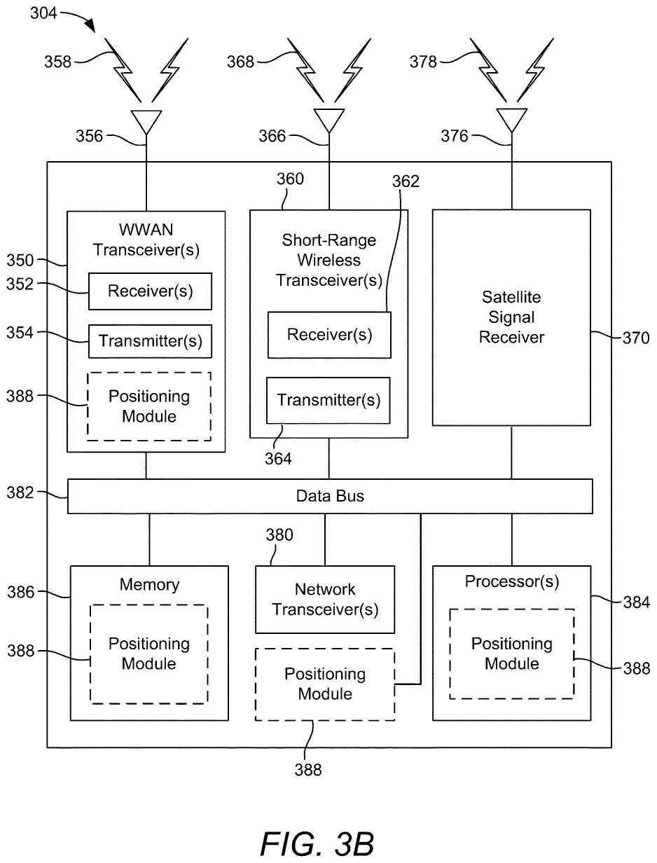

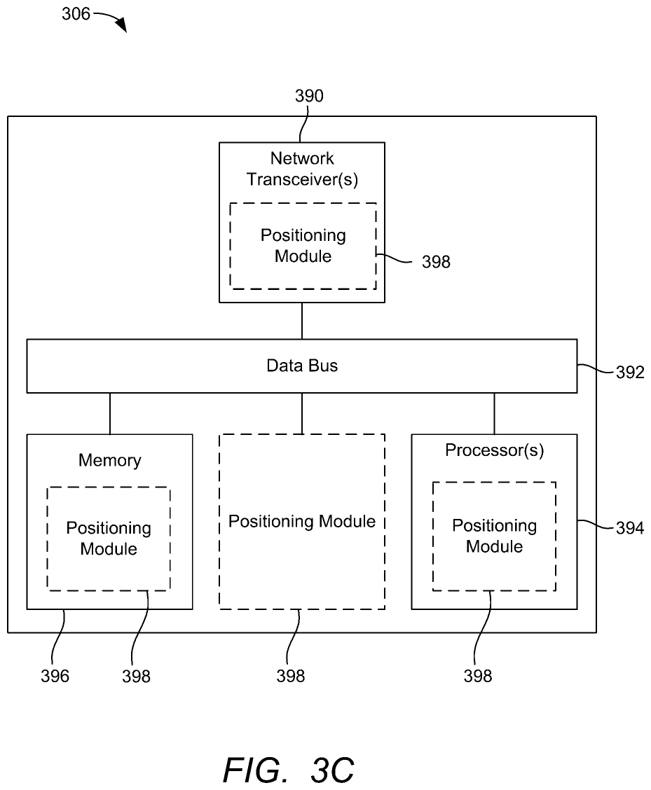

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning module 342, 388, and 398, respectively. The positioning module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning module 342, 388, and 398 may be external to the processors 332, 384, and 394 (e.g., part of a modem processing system, integrated with another processing system, etc.). Alternatively, the positioning module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning module 342, which may be, for example, part of the one or more WWAN transceivers 310, the memory 340, the one or more processors 332, or any combination thereof, or may be a standalone component. FIG. 3B illustrates possible locations of the positioning module 388, which may be, for example, part of the one or more WWAN transceivers 350, the memory 386, the one or more processors 384, or any combination thereof, or may be a standalone component. FIG. 3C illustrates possible locations of the positioning module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

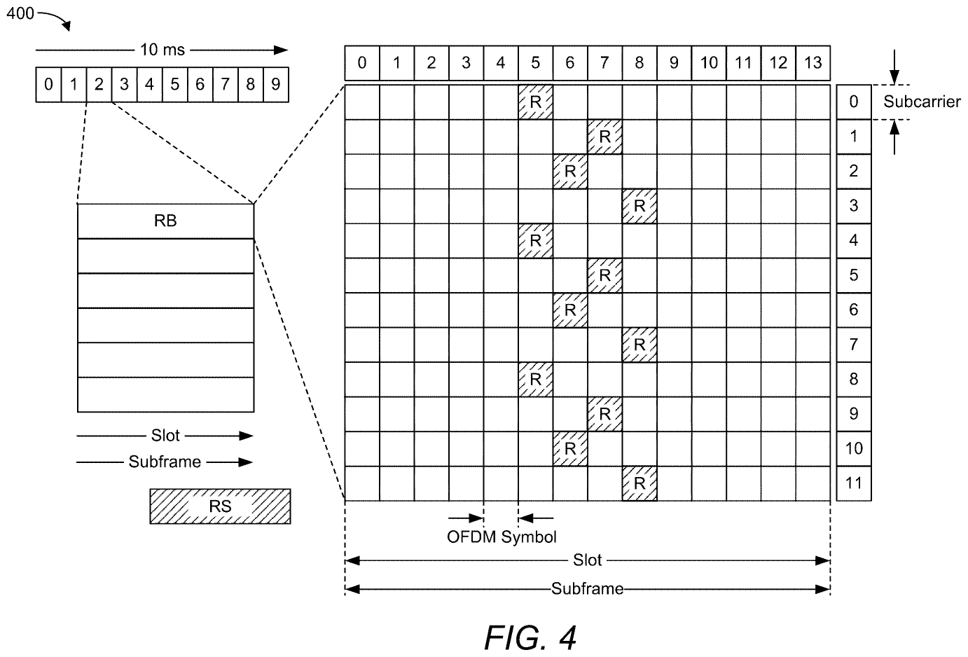

FIG. 4 is a diagram illustrating an example frame structure 400, according to aspects of the disclosure. Various frame structures may be used to support downlink and uplink transmissions between network nodes (e.g., base stations and UEs). The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 kHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

A collection of resource elements (REs) that are used for transmission of PRS is referred to as a “PRS resource.” The collection of resource elements can span multiple PRBs in the frequency domain and ‘N’ (such as 1 or more) consecutive symbol(s) within a slot in the time domain. In a given OFDM symbol in the time domain, a PRS resource occupies consecutive PRBs in the frequency domain.

The transmission of a PRS resource within a given PRB has a particular comb size (also referred to as the “comb density”). A comb size ‘N’ represents the subcarrier spacing (or frequency/tone spacing) within each symbol of a PRS resource configuration. Specifically, for a comb size ‘N,’ PRS are transmitted in every Nth subcarrier of a symbol of a PRB. For example, for comb-4, for each symbol of the PRS resource configuration, REs corresponding to every fourth subcarrier (such as subcarriers 0, 4, 8) are used to transmit PRS of the PRS resource. Currently, comb sizes of comb-2, comb-4, comb-6, and comb-12 are supported for DL-PRS. FIG. 4 illustrates an example PRS resource configuration for comb-4 (which spans four symbols). That is, the locations of the shaded REs (labeled “R”) indicate a comb-4 PRS resource configuration.

Currently, a DL-PRS resource may span 2, 4, 6, or 12 consecutive symbols within a slot with a fully frequency-domain staggered pattern. A DL-PRS resource can be configured in any higher layer configured downlink or flexible (FL) symbol of a slot. There may be a constant energy per resource element (EPRE) for all REs of a given DL-PRS resource. The following are the frequency offsets from symbol to symbol for comb sizes 2, 4, 6, and 12 over 2, 4, 6, and 12 symbols. 2-symbol comb-2: {0, 1}; 4-symbol comb-2: {0, 1, 0, 1}; 6-symbol comb-2: {0, 1, 0, 1, 0, 1}; 12-symbol comb-2: {0, 1, 0, 1, 0, 1, 0, 1, 0, 1, 0, 1}; 4-symbol comb-4: {0, 2, 1, 3} (as in the example of FIG. 4); 12-symbol comb-4: {0, 2, 1, 3, 0, 2, 1, 3, 0, 2, 1, 3}; 6-symbol comb-6: {0, 3, 1, 4, 2, 5}; 12-symbol comb-6: {0, 3, 1, 4, 2, 5, 0, 3, 1, 4, 2, 5}; and 12-symbol comb-12: {0, 6, 3, 9, 1, 7, 4, 10, 2, 8, 5, 11}.

A “PRS resource set” is a set of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a TRP ID). In addition, the PRS resources in a PRS resource set have the same periodicity, a common muting pattern configuration, and the same repetition factor (such as “PRS-ResourceRepetitionFactor”) across slots. The periodicity is the time from the first repetition of the first PRS resource of a first PRS instance to the same first repetition of the same first PRS resource of the next PRS instance. The periodicity may have a length selected from 2\hat{ }μ*{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set is associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” Note that this does not have any implications on whether the TRPs and the beams on which PRS are transmitted are known to the UE.

A “PRS instance” or “PRS occasion” is one instance of a periodically repeated time window (such as a group of one or more consecutive slots) where PRS are expected to be transmitted. A PRS occasion also may be referred to as a “PRS positioning occasion,” a “PRS positioning instance, a “positioning occasion,” “a positioning instance,” a “positioning repetition,” or simply an “occasion,” an “instance,” or a “repetition.”

A “positioning frequency layer” (also referred to simply as a “frequency layer”) is a collection of one or more PRS resource sets across one or more TRPs that have the same values for certain parameters. Specifically, the collection of PRS resource sets has the same subcarrier spacing and cyclic prefix (CP) type (meaning all numerologies supported for the physical downlink shared channel (PDSCH) are also supported for PRS), the same Point A, the same value of the downlink PRS bandwidth, the same start PRB (and center frequency), and the same comb-size. The Point A parameter takes the value of the parameter “ARFCN-ValueNR” (where “ARFCN” stands for “absolute radio-frequency channel number”) and is an identifier/code that specifies a pair of physical radio channel used for transmission and reception. The downlink PRS bandwidth may have a granularity of four PRBs, with a minimum of 24 PRBs and a maximum of 272 PRBs. Currently, up to four frequency layers have been defined, and up to two PRS resource sets may be configured per TRP per frequency layer.

The concept of a frequency layer is somewhat like the concept of component carriers and bandwidth parts (BWPs), but different in that component carriers and BWPs are used by one base station (or a macro cell base station and a small cell base station) to transmit data channels, while frequency layers are used by several (usually three or more) base stations to transmit PRS. A UE may indicate the number of frequency layers it can support when it sends the network its positioning capabilities, such as during an LTE positioning protocol (LPP) session. For example, a UE may indicate whether it can support one or four positioning frequency layers.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink, uplink, or sidelink positioning reference signals, unless otherwise indicated by the context. If needed to further distinguish the type of PRS, a downlink positioning reference signal may be referred to as a “DL-PRS,” an uplink positioning reference signal (e.g., an SRS-for-positioning, PTRS) may be referred to as an “UL-PRS,” and a sidelink positioning reference signal may be referred to as an “SL-PRS.” In addition, for signals that may be transmitted in the downlink, uplink, and/or sidelink (e.g., DMRS), the signals may be prepended with “DL,” “UL,” or “SL” to distinguish the direction. For example, “UL-DMRS” is different from “DL-DMRS.”

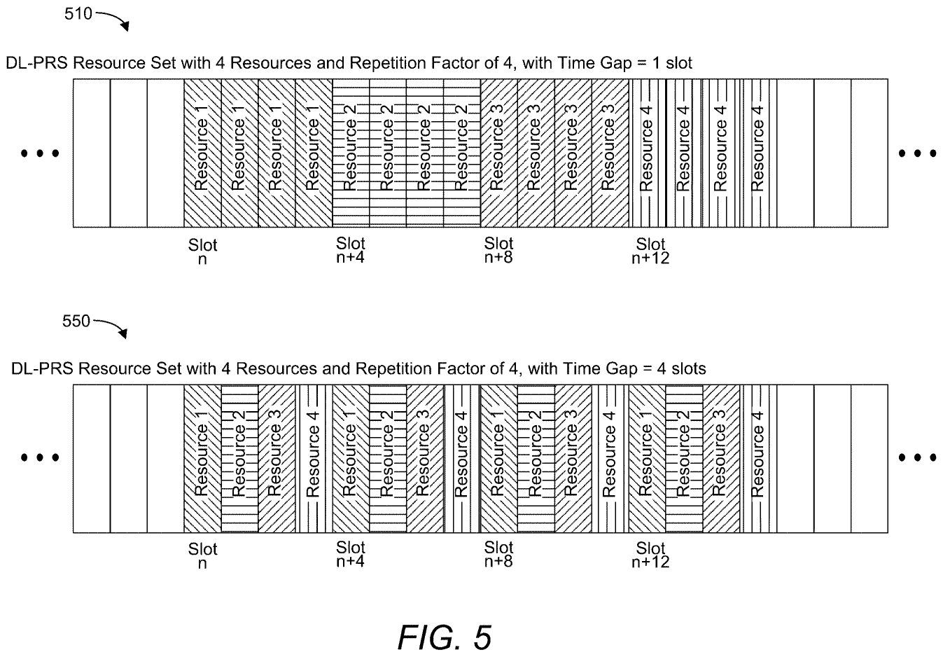

FIG. 5 is a diagram of example PRS resource repetition and beam sweeping options, according to aspects of the disclosure. In the example of FIG. 5, time is represented horizontally and frequency is represented vertically. Each block represents a slot in the time domain and some bandwidth in the frequency domain.

FIG. 5 illustrates instances (or occasions) of two DL-PRS resource sets, a first DL-PRS resource set 510 and a second DL-PRS resource set 550. Each DL-PRS resource set 510 and 550 comprises four PRS resources (labeled “Resource 1,” “Resource 2,” “Resource 3,” and “Resource 4”) and has a repetition factor of four. A repetition factor of four means that each of the four PRS resources is repeated four times (i.e., is transmitted four times) within the DL-PRS resource set. That is, there are four repetitions of each of the four PRS resources within the DL-PRS resource set. The repetition factor may be configured to the UE by the higher layer parameter “PRS-ResourceRepetitionFactor,” and may have a value selected from the set {1, 2, 4, 6, 8, 16, 32}. Note that the time duration spanned by one DL-PRS resource set containing repeated DL-PRS resources, as illustrated in FIG. 5, should not exceed the PRS periodicity.

In the example of FIG. 5, the DL-PRS resource set 510 and the DL-PRS resource set 550 have different time gaps. The time gap is the offset in units of slots between two repeated instances of a DL-PRS resource corresponding to the same PRS resource ID within a single instance of a DL-PRS resource set. The time gap may be configured to the UE by the higher layer parameter “PRS-ResourceTimeGap,” and may have a value selected from the set {1, 2, 4, 8, 16, 32}.

In FIG. 5, the DL-PRS resource set 510 has a time gap of one slot, meaning that each repetition of a PRS resource (e.g., “Resource 1”) starts on the first slot after the previous repetition of that PRS resource. Thus, as illustrated for DL-PRS resource set 510, the four repetitions of each of the four PRS resources are grouped together. Specifically, the four repetitions of PRS resource “Resource 1” occupy the first four slots (i.e., slots n to n+3) of the DL-PRS resource set 510, the four repetitions of PRS resource “Resource 2” occupy the second four slots (i.e., slots n+4 to n+7), the four repetitions of PRS resource “Resource 3” occupy the third four slots (i.e., slots n+8 to n+11), and the four repetitions of PRS resource “Resource 4” occupy the last four slots (i.e., slots n+12 to n+15).

In contrast, the DL-PRS resource set 550 has a time gap of four slots, meaning that each repetition of a PRS resource (e.g., “Resource 2”) starts on the fourth slot after the previous repetition of that PRS resource. Thus, as illustrated by DL-PRS resource set 550, the four repetitions of each of the four PRS resources are scheduled every fourth slot. For example, the four repetitions of PRS resource “Resource 1” occupy the first, fifth, ninth, and thirteenth slots (i.e., slots n, n+4, n+8, and n+12) of the DL-PRS resource set 550.

The purposes of repetition of a PRS resource is to permit receive beam sweeping (e.g., by the UE) across the repetitions of the PRS resource, to enable the receiver to combine signal gains for coverage extension, and to allow for intra-instance muting (e.g., if one repetition is muted, there are still other repetitions for the receiver to measure). Note that UE receive beam sweeping is up to UE implementation.

RF sensing is the use of radio frequency signals and their reflections to detect the presence of an object in target volume and optionally its relative motion or change of attitude in 3D space. RF positioning, by contrast, is a ranging operation that attempts to determine an exact distance from one or more RF transmitters and/or receivers, and optionally calculate a location of the object in 3D space, via trilateration or other positioning calculation. RF positioning uses RF sensing, but RF sensing does not necessarily provide an exact (or even estimated) location of the object being sensed.

In NR, positioning signals DL-PRS, SL-PRS, and UL-PRS are OFDM signals rather than frequency modulated continuous wave (FMCW) signals, but FMCW signals are being considered for positioning and sensing. A typical FMCW TX signal is a signal that starts at one frequency and changes its frequency (e.g., linearly increasing) over time until it reaches an end frequency, at which time the signal stops. Such as signal is called a “chirp”, and can be specified mathematically as:

$$x ( t ) = {e}^{- j 2 π ( {f}_{c} + \frac{B}{T} ) t} , during time 0 \leq t \leq T$$

$$and$$

$$x ( t ) = 0 , during time T < t \leq T + {T}_{g}$$

where f_{c} is the starting frequency, B=signal bandwidth, T=time duration of each chirp transmission, and T_{g}=guard time. For the monostatic scenario, the receiver has access to the time-synchronized TX signal:

$$r ( t ) = {\sum }_{i} {h}_{i} x ( t - \frac{2 {R}_{i}}{c} ) + n ( t )$$

Where hᵢ is the channel gain, Rᵢ is the range to the reflector, c is the speed of light, n(t) is noise. In a monostatic scenario, where there are multiple targets in the vicinity, each target being at a distance Rᵢ, the TX signal is transmitted and the RX signal is a linear combination of the reflections from the multiple targets, where

$$\frac{2 {R}_{i}}{c}$$

is the time delay from the transmitter to the target and back.

Match filtering is then performed, where φᵢ is a phase quantity independent of t:

$$r ( r ) {x}^{*} ( t ) = {\sum }_{i} {h}_{i} {e}^{- j 2 π ( {f}_{c} + \frac{B}{T} ( t - \frac{2 {R}_{i}}{c} ) ) ( f - \frac{2 {R}_{i}}{c} ) + j 2 π ( {f}_{c} + \frac{B}{T} t ) t} = {\sum }_{i} {h}_{i} {e}^{j {ϕ}_{i}} {e}^{- \frac{j 2 π 2 {BR}_{i}}{c T}} .$$

Match filtering can be performed because it can be presumed that there is not time offset between the transmitter and the receiver, e.g., they are using the same clock or a same time reference signal is provided to both of them. Since the RX signal is expressed as a sum of sinusoids, taking the fast Fourier transform (FFT) of the signal and measuring the peaks in frequency gives the scaled range for each reflector. (If there is only one peak, there is only one reflector.) The value of a peak corresponds to the component

$$\frac{2 {BR}_{i}}{c \cdot T} :$$

the values of B, c, and T are known, so the value of the range Rᵢ can be derived.

FMCW has some distinct benefits. For example, mapping FMCW signal to NR signal parameters f_{c}=60 GHz (e.g., in an unlicensed band), B=400 MHz, the maximum range to be sampled Rₘₐₓ=150m, and the chirp duration is one symbol duration at a subcarrier spacing of 120 kHz, e.g., T=8.33 μs, results in a maximum observed frequency that can be expected to be present in the processed

$$RX signal = \frac{2.4 {e}^{6} \cdot 150 \cdot 120 {e}^{3}}{3 {e}^{8}} = 48 MHz .$$

Thus, the sampling frequency for the 48 MHz FMCW signal can be much smaller than the sampling frequency needed for a 400 MHz OFDM symbol occupying the same duration of time. The chirp can be generated by an analog front-end, and a simpler receiver can process the 48 MHz signal.

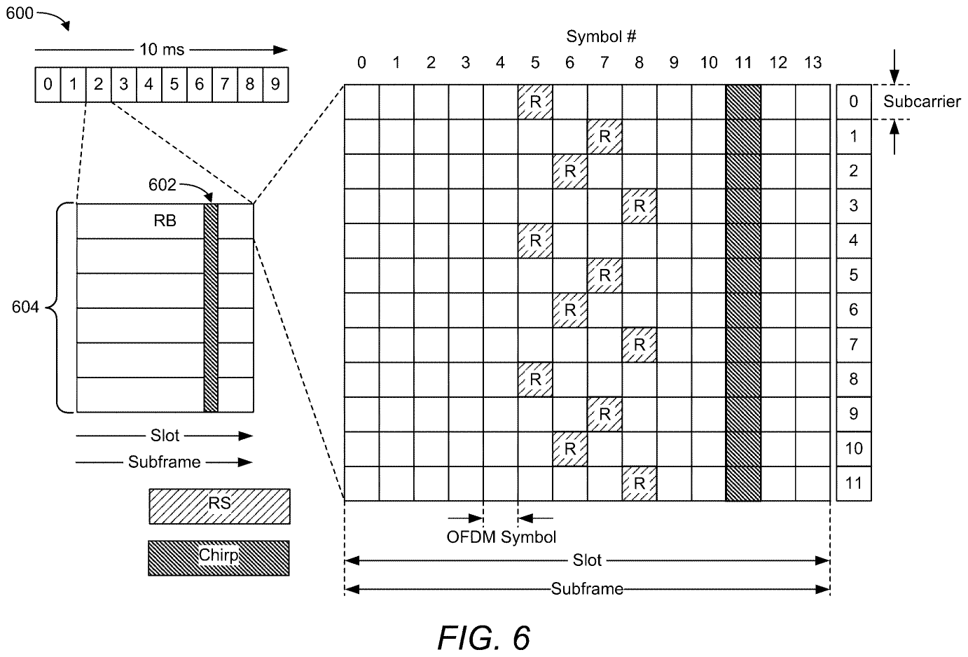

FIG. 6 is a diagram illustrating an example frame structure 600 with an FMCW chirp 602, according to aspects of the disclosure. The frame structure may be a downlink or uplink frame structure. Other wireless communications technologies may have different frame structures and/or different channels. LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 6, a numerology of 15 kHz is used. Thus, in the time domain, a 10 ms frame is divided into 10 equally sized subframes of 1 ms each, and each subframe includes one time slot. In FIG. 6, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 6, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 6 illustrates example locations of REs carrying a reference signal (labeled “R”).

In the example shown in FIG. 6, the frame 600 also includes a chirp 602 in OFDM symbol position 11. As shown in FIG. 6, the chirp 602 occupies the entire bandwidth 604 which has been allocated to the UE, but in other aspects, the chirp 602 may occupy less than the entire bandwidth 604.

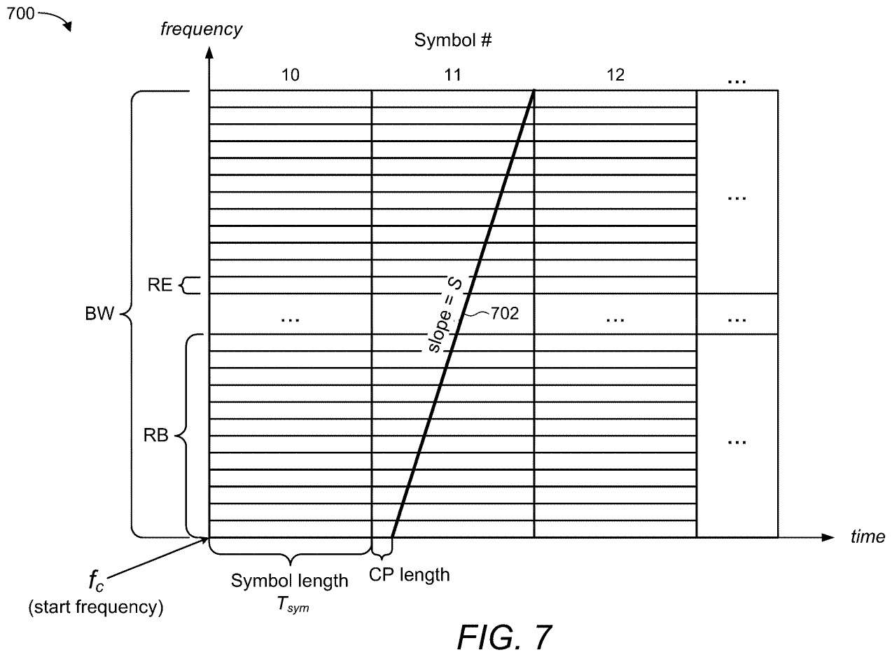

FIG. 7 is a diagram illustrating in more detail a portion of an example frame structure 700 with an FMCW chirp 702, according to aspects of the disclosure. As shown in FIG. 7, the chirp 702 transmit frequency increases with time, e.g., f_{TX}(t)=f_{c}+St. The chirp 702 transmitted in a symbol length can be represented as

$${x}_{RF , Tx} ( t ) = cos ( 2 π ( {f}_{c} + \frac{s}{2} t ) t + {ϕ}_{gNB} ) ,$$

where the slope

$$S = \frac{B W}{{T}_{s y m}} = \frac{{N}_{R E} \cdot Δ f}{{T}_{s y m}} .$$

Increasing the slope S to provide multiple, non-overlapping chirps from the same TRP has the disadvantage that a higher analog-to-digital converter (ADC) sampling rate would be required at the receiver in order to avoid losing positioning resolution.

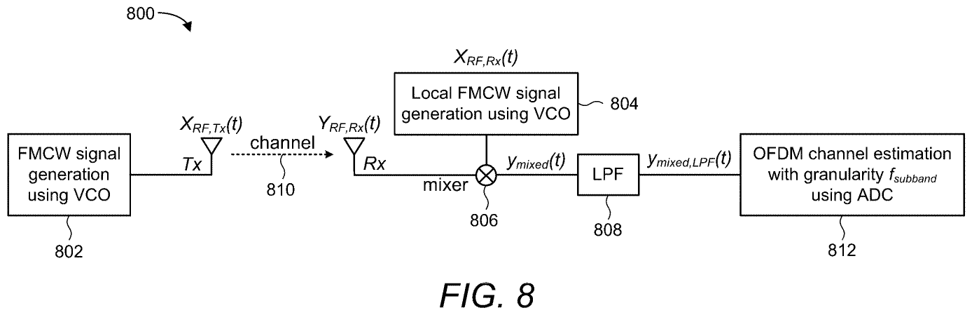

FIG. 8 is a block diagram of an example system 800 that can perform channel estimation, positioning and sensing based on FMCW waveform, according to aspects of the disclosure. On the transmitter side, an FMCW signal is generated using a voltage-controlled oscillator (VCO) 802 in the analog domain:

$${x}_{R F , T x} ( t ) = cos ( 2 π ( {f}_{c} + \frac{s}{2} t ) t + {ϕ}_{gNB} ) .$$

On the receiver side, the RF signal received is:

$${y}_{R F , R x} ( t ) = {\sum }_{p = 0}^{P - 1} {A}_{p} {x}_{RF , gNB} ( t - {τ}_{p} ) + n ( t ) .$$

A local FMCW signal will be generated using a second VCO 804 in the analog domain:

$${x}_{RF , UE} ( t ) = exp ( - j ( 2 π ( {f}_{c} + \frac{s}{2} t ) t + {ϕ}_{UE} ) )$$

and provided to a mixer 806 along with y_{RF,Rx}(t). The mixed signal, y_{mixed}(t), is provided to a low-pass filter (LPF) 808. The output of the LPF 808 is a signal:

$${y}_{m i x e d , L P F} ( t ) = L P F [ {y}_{RF , Rx} ( t ) {x}_{RF , UB} ( t ) ] = {\sum }_{p = 0}^{P - 1} {β}_{p} exp ( - j 2 π S {τ}_{p} \cdot t )$$

where

$${β}_{p} = \frac{{A}_{p}}{2} exp ( − j ( 2 π {f}_{c} {τ}_{p} ) ) exp ( j ( 2 π ( \frac{S}{2} {τ}_{p} ) {τ}_{p} + {ϕ}_{UE} + {ϕ}_{gNB} ) )$$

The OFDM channel 810 with granularity f_{subband} can be estimated in block 812 by sampling y_{mixed,LPF}(t) at rate

$${T}_{S} = \frac{1}{{F}_{S}} = \frac{{f}_{subbana}}{S} ,$$

resulting in

$$\begin{matrix}{D}_{Rx} ( k ) = {\sum }_{p = 0}^{P - 1} {β}_{p} exp ( - j 2 π S {τ}_{p} \cdot \frac{k}{{F}_{s}} ) = {\sum }_{p = 0}^{P - 1} {β}_{p} exp ( - j 2 {πτ}_{p} \cdot k \cdot {f}_{subbαnd} ) , k \\ = 0 , 1 , … , {N}_{subbana} - 1\end{matrix}$$

Here, D_{Rx}(k) with k=0,1, . . . , N_{subband}−1 is the channel response of the kth subband.

The benefit of this approach is that no fast Fourier transform (FFT) is necessary at the receiver; instead, the frequency-domain OFDM channel can be estimated directly in the time-domain using a low-rate sampling. Moreover, the received FMCW signal y_{mixed,LPF}(t) can also be used for UE positioning and target object sensing.

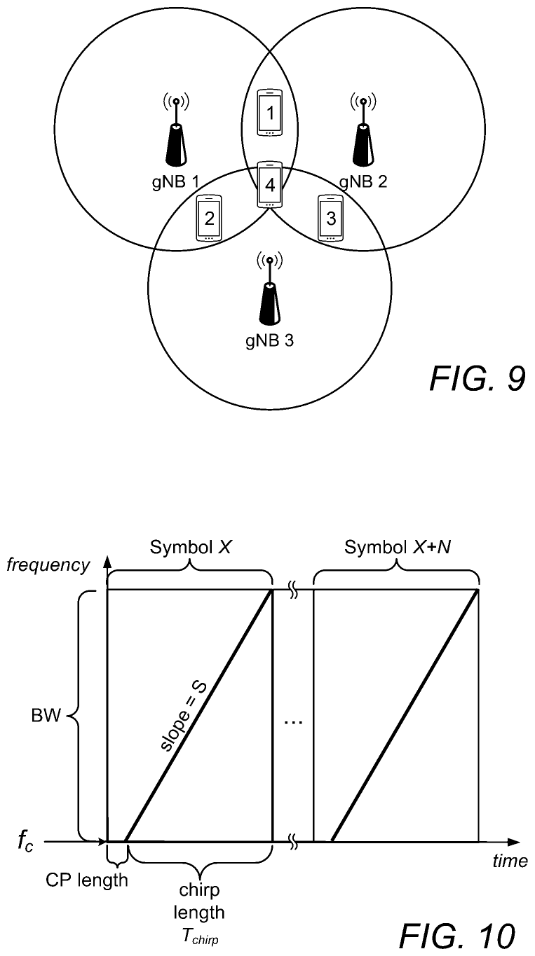

FIG. 9 illustrates a disadvantage of using FMCW waveforms for PRS, however-namely, that a UE at the edge of a cell may receive additional PRS signals from multiple cells, and that the FMCW waveform for PRS (which may be referred to hereinafter as a “PRS chirp”) transmitted by each cell occupies the entire bandwidth. In the example illustrated in FIG. 9, UE1 may receive PRS chirps from both gNB1 and gNB2; UE2 may receive PRS chirps from both gNB1 and gNB3; UE3 may receive PRS chirps from both gNB2 and gNB3; and UE4 may receive PRS chirps from gNB1, gNB2, and gNB3.

If the PRS signals of the multiple cells are transmitted at identical radio resources, they may cause mutual interference and thus cause positioning error at UE. For OFDM-based PRS signals, the solution supported by the current NR standards is to separate the OFDM-based PRS signals by frequency division multiplexing (FDM), e.g., by providing several frequency comb offset options. In this manner, neighbor cells can be configured with different offsets to avoid mutual-cell interference. However, because each cell's PRS chirp occupies the whole bandwidth, PRS chirps cannot be separated by FDM.

FIG. 10 illustrates a conventional approach to solve the problem illustrated in FIG. 9—namely, to separate the chirps by time-division multiplexing (TDM) in which each chirp is allocated its own symbol within the frame. This increases the radio resource consumption, since the PRS chirps occupy the entire bandwidth for N number of symbols, during which OFDM-based signaling and data transmission cannot occur. What is needed is a technique that does not suffer the disadvantages of the conventional approach shown in FIG. 10.

Accordingly, techniques for multi-cell interference mitigation for PRS transmission with FMCW-based waveforms are presented herein, along with signaling for configuring FMCW waveform parameters for per-cell PRS and for exchanging inter-cell messages to avoid multi-cell interference.

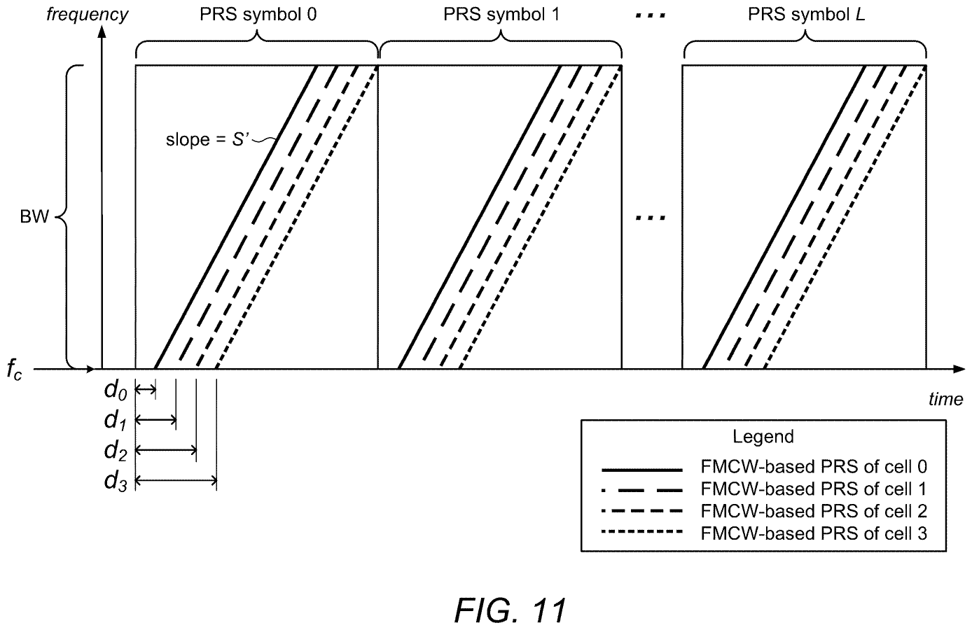

FIG. 11 is a time and frequency graph illustrating one technique for multi-cell interference mitigation for PRS transmission with FMCW-based waveforms, according to aspects of the disclosure. FIG. 11 shows FMCW-based PRS signals with partial time-domain overlap in multiple cells, which avoids mutual-cell interference and only slightly increases the ADC sampling rate required to process the PRS chirps. Because the PRS chirps partially overlap in time, this embodiment is referred to herein as partial-overlapping-based multi-cell FMCW wave multiplexing. This technique greatly reduces the overall radio resource consumption on multi-cell PRS transmission.

In the example shown in FIG. 11, the FMCW-based PRS signals from four different cells, labeled cell 0 through cell 3, occur within each symbol, but at different time offsets or time delays, labelled do through d₃. The slope of each PRS chirp is S′, which has a value between the slopes S and N*S in FIG. 10, e.g., S<S′<N*S. The slightly higher slope S′ requires a slightly higher ADC sampling rate compared to S but not as high as the ADC sampling rate required to process a PRS chirp having a slope of N*S. Because the PRS chirps from all four cells occur within one symbol, the minimum number of symbols required to support all four cells is one, but, as shown in FIG. 11, additional symbols may also be used for the PRS chirps for additional accuracy and/or resolution.

In some aspects, a gNB configures a UE with the FMCW-based PRS resource for the serving cell (and optionally, the FMCW-based PRS resources for neighboring cells). In some aspects, the configuration information contains one or more general parameters and one or more FMCW related parameters. Examples of general parameters include number of symbols (L_{PRS}), and start of symbol index

$$( {l}_{start}^{PRS} ) ,$$

which exist in the current NR standards. Examples of FMCW related parameters, which do not exist in the current NR standards, include, but are not limited to, the following: cell-common parameters, such as start carrier f_{c}, bandwidth BW, chirp slope S, inter-cell offset minimum gap G_{d}, and maximum number of per-cell time offsets Na; and cell-specific parameters, such as per-cell time offset d, including d_{serving}, d_{neighbor,1}, d_{neighbor,2}, . . . , which are distinct between two neighbor cells.

In some aspects, FMCW related parameters may follow configuration rules, such as a requirement that the configured values of bandwidth BW, chirp slope S and per-symbol time offset d should satisfy

$$d + \frac{BW}{s} \leq {T}_{symbol} ,$$

where T_{symbol} is the time length of one OFDM symbol.

In some aspects, per-cell time offsets d may be configured according to the following process. First, the standard regulates a set of candidate values S for per-cell time offsets, then the serving gNB selects one candidate value for each of its controlled cell(s). For example, in some aspects, [symbol] ={0,1, . . . , N_{d}−1}×G_{d}; in other aspects,

$$𝕊 = \{ 0 , 1 , … , {N}_{d} - 1 \} \times \frac{{T}_{symbol}}{{N}_{d}} .$$

In some aspects, the gNB sends messages to its served UE(s) to indicate the time offset for PRS of serving cell d_{serving} and optionally the time offset for each neighbor cell {d_{neighbor,i}}ᵢ. In some aspects, the gNB explicitly configures the index of d_{serving}, d_{neighbor,i}. In some aspects, the standard regulates (or the gNB first configures) the maximum number of per-cell time offsets Na, then the gNB configures the index of per-cell time offset is associated with a cell-related parameter. For example, in some aspects, the index of d_{serving} or d_{neighbor} is associated with the cell ID of the serving cell, d_{serving}=cell_ID_serving mod N_{d}, or the neighbor cell, d_{neighbor}=cell_ID_neighbor mod N_{d}.

In the partial-overlapping-based multi-cell FMCW wave multiplexing embodiment, the partially overlapping PRS chirps provide benefits to the UE, such as a lower ADC sampling rate compared to non-overlapping PRS chirps in the same symbol, with the cost that additional baseband processing is needed to separate the partially overlapping PRS chirps.

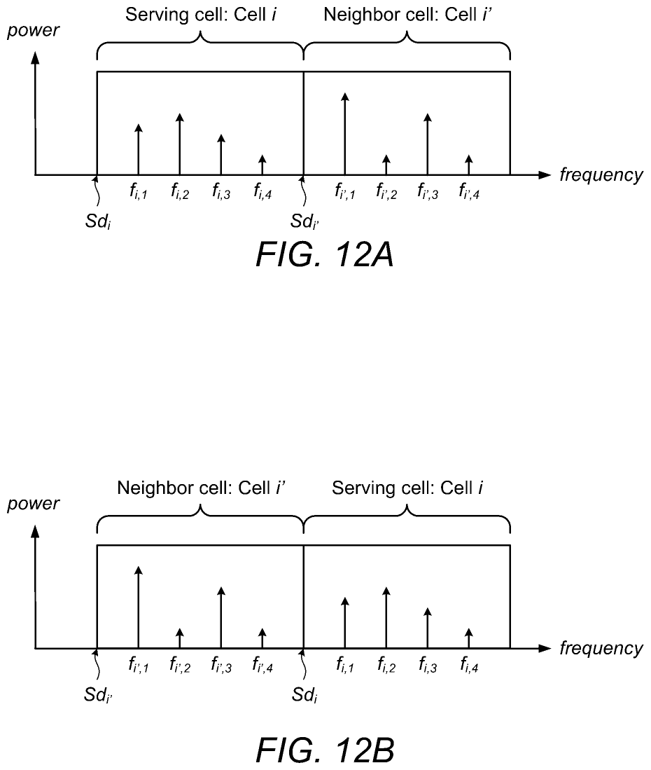

FIG. 12A and FIG. 12B show example values of signal power measured by a UE across a range of frequencies, according to aspects of the disclosure. While a cell-edge UE may receive PRS chirps from 1 serving cell and N_{cell}−1 neighbor cells, each of FIG. 12A and FIG. 12B shows an example where there is just one neighbor cell, which occupies a higher frequency than the serving cell (FIG. 12A) or a lower frequency than the serving cell (FIG. 12B).

The post-processing (multiplying local FMCW wave and passing LPF) of the signal is represented by the equation:

$${\tilde{y}}_{mixed , LPF , all} ( t ) = {\sum }_{i = 1}^{{N}_{cell}} {\tilde{y}}_{mixed , LPF , i} ( t ) = {\sum }_{i = 1}^{{N}_{cell}} {\tilde{β}}_{i , p} exp ( - j 2 π S ( {τ}_{i , p} + {d}_{i} ) \cdot t ) .$$

This can be regarded as aggregation of multiple carriers with frequencies {f_{i,p}=S(τ_{i,p}+dᵢ)}_{i,p}. Therein, the frequencies of neighbor cell (Cell i′) doesn't overlap the frequencies of serving cell (Cell i) when

$${d}_{{i}^{′}} - {d}_{i} \geq {max}_{p} {τ}_{i , p} ( if {d}_{{i}^{′}} > {d}_{i} )$$

$$or$$

$${d}_{i} - {d}_{{i}^{′}} \geq {max}_{p} {τ}_{{i}^{′} , p} ( if {d}_{i} > {d}_{{i}^{′}} ) .$$

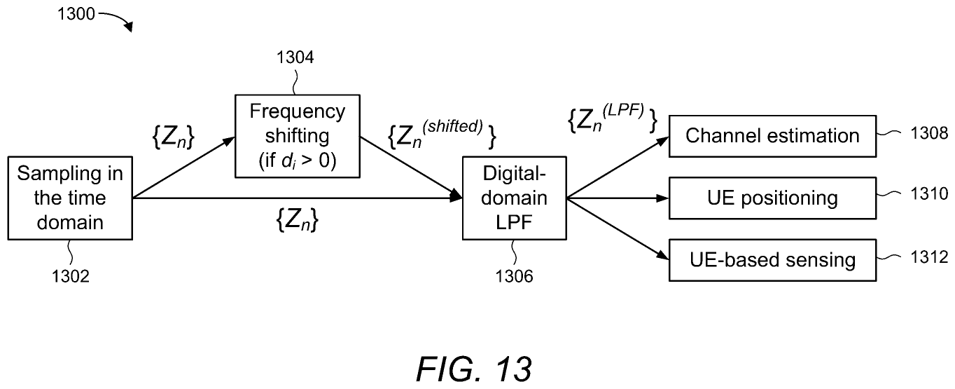

The UE or other receiving entity can extract the signal of serving cell from \tilde{y}_{mixed,LPF,all}(t) by performing frequency shifting and using a low-pass filter (LPF). This is shown in more detail in FIG. 13.

FIG. 13 illustrates an example process 1300, that may be performed by the UE or other receiving entity, associated with multi-cell interference mitigation for PRS transmission with FMCW-based waveforms, according to aspects of the disclosure. The process 1300 may include sampling in the time domain (block 1302), frequency shifting (block 1304), digital domain low pass filtering (block 1306) and either channel estimation (block 1308), estimating a UE position (block 1310), performing UE-based sensing (block 1312), or a combination thereof. For example:

If the serving cell's offset dᵢ=0:
do sampling in time domain, zₙ=\tilde{y}_{mixed,LPF,all}(nTₛ), n=0~N_{subband};
perform digital-domain LPF to {zₙ} with cutoff frequency SG_{d},

$$\{ {z}_{n}^{( LPF )} \} = LPF ( \{ {z}_{n} \} ) ;$$

and
estimate the channel in the same way as for basic FMCW waveform or do positioning/sensing related processing based on

$$\{ {z}_{n}^{( LPF )} \} .$$

If the serving cell's offset dᵢ>0:
do sampling in time domain, zₙ=\tilde{y}_{mixed,LPF,all}(nTₛ), n=0~N_{subband};
perform frequency shifting by

$${z}_{n}^{( shifted )} = {z}_{n} {e}^{j 2 π ( n - 1 ) {T}_{s} {Sd}_{i}} ;$$

perform digital-domain LPF to

$$\{ {z}_{n}^{( shifted )} \}$$

with cutoff frequency SG_{d},

$$\{ {z}_{n}^{( LPF )} \} = LPF ( \{ {z}_{n}^{( shifted )} \} ) ;$$

and
estimate the channel in the same way as for basic FMCW waveform or do positioning/sensing related processing based on

$$\{ {z}_{n}^{( LPF )} \} .$$

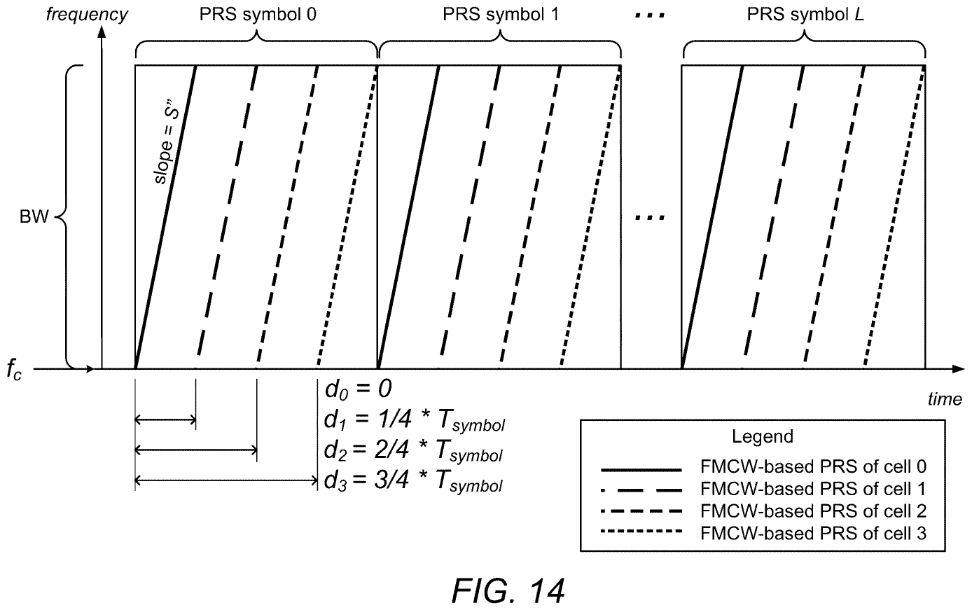

FIG. 14 is a time and frequency graph illustrating another technique for multi-cell interference mitigation for PRS transmission with FMCW-based waveforms, according to aspects of the disclosure. As shown in FIG. 14, the configuration methods disclosed herein may be used for TDM-based multi-cell PRS involving PRS chirps that are non-overlapping. In FIG. 14, each non-overlapping chirp location, i.e., each time offset, is assigned to a different cell. The benefit is that baseband processing to separate the FMCW chirps from each other is not needed, but the cost is that the UE has a higher sampling rate because of the increased slope of each chirp. In some aspects, there may be at least two chirp configurations-overlapping and non-overlapping—to choose from, based on other factors, such as the specific value of other configuration parameters, for example.

In some cases, the choice between using overlapping PRS chirps or using non-overlapping PRS chirps may depend on the value of the inter-cell offset minimum gap G_{d}. For example, if

$${G}_{d} < \frac{BW}{S} ,$$

then overlapping PRS chirps may be used, and the UE or other receiving entity will perform baseband processing to separate the FMCW signals, but if

$${G}_{d} \geq \frac{BW}{S} ,$$

then the non-overlapping PRS chirps may by used, and the UE or other receiving entity doesn't perform baseband processing to separate the FMCW signals.

Signaling design to configure FMCW, including inter-cell signaling messages, is also herein presented. In some aspects, in order to guarantee different per-cell time offset between two neighbor cells, the serving cell and neighboring cell(s) may exchange inter-cell signaling messages on FMCW based PRS configuration. In some aspects, in order to accelerate handover, the target gNB can indicate the source gNB with FMCW-based PRS configuration in the target cell. After handover, the UE can check whether FMCW-based PRS configuration confliction exists between the source cell and the target cell, and then report the result.

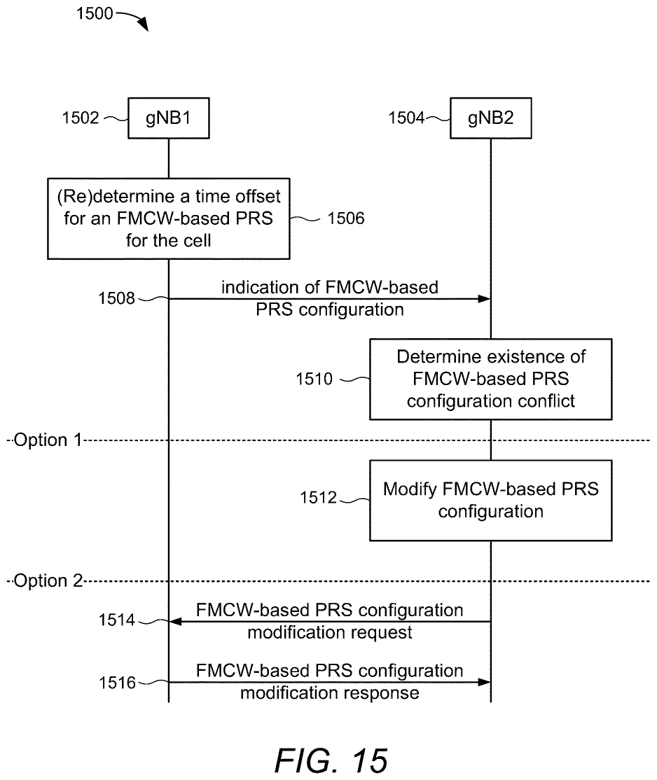

FIG. 15 is a signaling and event diagram 1500 illustrating inter-cell signaling messages associated with multi-cell interference mitigation for PRS transmission with FMCW-based waveforms, according to aspects of the disclosure. The example illustrated in FIG. 15 involves an interaction between a first gNB (gNB1) 1502 in a first cell and a second gNB (gNB2) 1504 in a second cell that is a neighbor to the first cell.

In the example illustrated in FIG. 15, at block 1506, the gNB1 1502 determines or re-determines a first time offset for an FMCW-based PRS time offset for its cell. At block 1508, the gNB1 1502 sends one or more messages to the gNB2 1504, including a first FMCW-based PRS configuration that indicates the first time offset. In some aspects, the one or more messages may be XnAP messages sent over an Xn-C interface. In some aspects, the one or more messages contain the cell ID and the FMCW-based configuration for the first cell.

At block 1510, the gNB2 1504 checks whether the first FMCW-based PRS configuration conflicts with a second FMCW-based PRS configuration used by the second cell or any cell that neighbors the second cell. In the example shown in FIG. 15, the gNB2 1504 determines that there is such a conflict, and at block 1512, the gNB2 1504 either modifies its own second FMCW-based PRS configuration at block 1512 (option 1), or sends an FMCW-based PRS configuration modification request message at block 1514 (option 2). In some aspects, the request message may contain the cell ID of the cell that needs to be modified, the suggested FMCW-based PRS configuration, or both. If the gNB1 1502 receives such a modification request message, the gNB1 1502 may determine whether it can make modification to solve the confliction, and may send an FMCW-based PRS configuration modification response message (block 1516) to indicate the modification result.

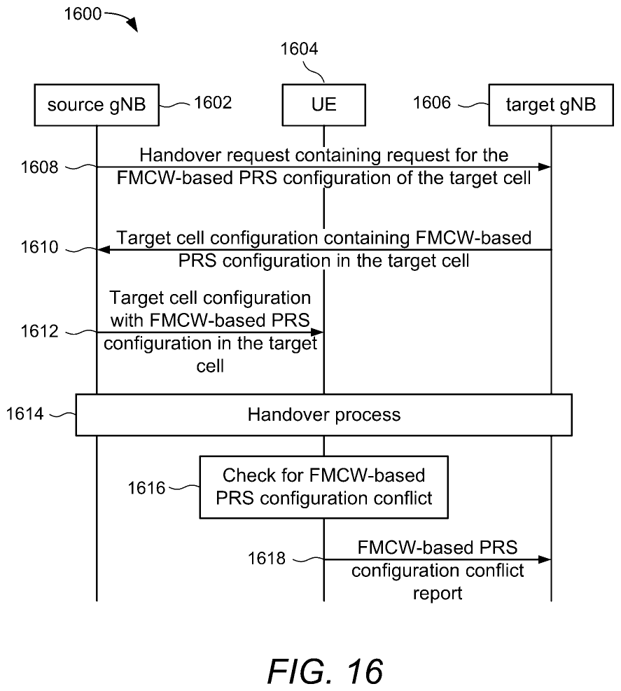

When a UE moves to cell edge and is about to perform handover, the gNB of the source cell can request the FMCW-based PRS configuration from the gNB of the target cell, and then forward this information to this UE. This can assist the UE to accelerate channel estimation, positioning or sensing based on the FMCW-based PRS in the target cell. An example of this is shown in FIG. 16.

FIG. 16 is a signaling and event diagram 1600 illustrating inter-cell signaling messages associated with multi-cell interference mitigation for PRS transmission with FMCW-based waveforms, according to aspects of the disclosure. The example illustrated in FIG. 16 involves an interaction between a source gNB 1602 that is serving a UE 1604 in a first cell, and target gNB 1606 in a second cell that is a neighbor to the first cell.

In the example illustrated in FIG. 16, at block 1608, the source gNB 1602 sends to the target gNB 1606 a handover request that contains a request for the FMCW-based PRS configuration of the target cell In some aspects, the handover request may contain the cell ID of the target cell. At block 1610, the target gNB 1606 responds with the target cell configuration that includes the FMCW-based PRS configuration of the target cell. In some aspects, this interaction between the source gNB 1602 and the target gNB 1606 may be via an exchange of XnAP messages in an Xn-C interface.

In the example illustrated in FIG. 16, at block 1612, the source gNB 1602 sends to the UE 1604 the target cell configuration that includes the FMCW-based PRS configuration of the target cell.

In the example illustrated in FIG. 16, the source gNB 1602, the UE 1604, and the target gNB 1606 engage in a handover process 1614 by which the target gNB 1606 becomes the new serving gNB for the UE 1604.

After UE 1604 finishes handover and connects to the target gNB 1606, the UE 1604 can check whether the FMCW-based PRS configurations of source cell and target cell have confliction. If there is a conflict, the UE 1604 can notify the target gNB 1606. In the example illustrated in FIG. 16, at block 1616, the UE 1604 determines whether there is an FMCW-based PRS configuration conflict, and at block 1618, the UE 1604 sends to the target gNB 1606 an FMCW-based PRS configuration conflict report. In some aspects, this configuration conflict report may include the cell IDs of source cell and target cell that have the PRS configuration conflict.

FMCW-based PRS has the benefit of lower Rx baseband processing complexity (including lower ADC sampling rate) than OFDM-based PRS. Proposed partial-overlapping-based FMCW-based PRS has the benefit of lower ADC sampling rate than TDM-based FMCW-based PRS. Protocol and signaling to enable FMCW-based PRS and mitigate inter-cell interference are herein presented. The disclosed signaling between cells enables FMCW-based PRS while mitigating inter-cell interference, to the benefit of both serving cells and neighboring cells.

Changes to the existing standards may include the following: providing a mechanism by which the gNB can configure a UE with the FMCW-based PRS resource for serving cell and neighbor cells; specifying a transmission format of FMCW-based PRS; and defining the inter-cell signaling messages.

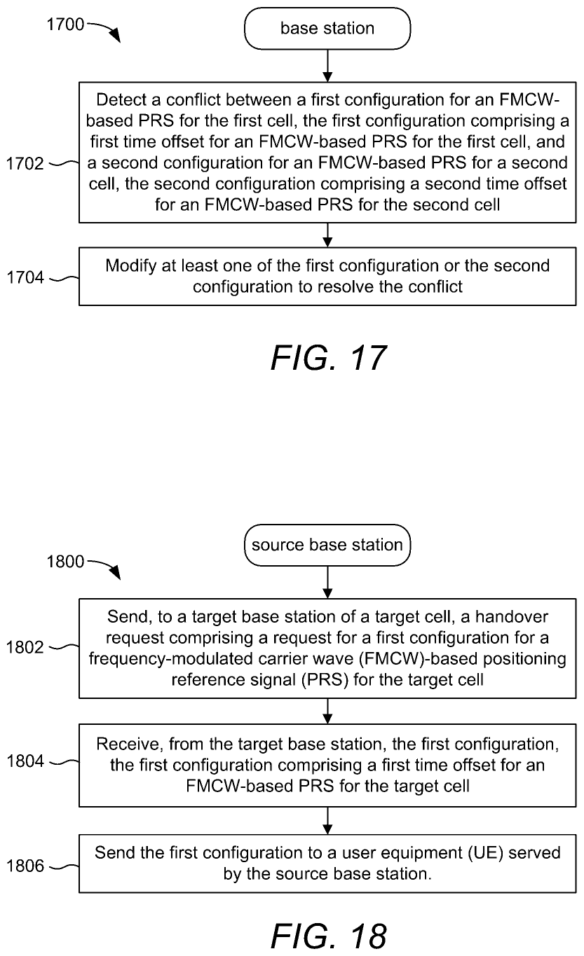

FIG. 17 is a flowchart of an example process 1700 associated with multi-cell interference mitigation for PRS transmission with FMCW-based waveforms, according to aspects of the disclosure. In some implementations, one or more process blocks of FIG. 17 may be performed by a first base station (e.g., first base station 102). In some implementations, one or more process blocks of FIG. 17 may be performed by another device or a group of devices separate from or including the first base station. Additionally, or alternatively, one or more process blocks of FIG. 17 may be performed by one or more components of BS 304, such as processor(s) 384, memory 386, WWAN transceiver(s) 350, short-range wireless transceiver(s) 360, satellite signal receiver 370, network transceiver(s) 380, and positioning module(s) 388, any or all of which may be means for performing the operations of process 1700.

As shown in FIG. 17, process 1700 may include, at block 1702, detecting a conflict between a first configuration for an FMCW-based PRS for the first cell, the first configuration comprising a first time offset for an FMCW-based PRS for the first cell, and a second configuration for an FMCW-based PRS for a second cell, the second configuration comprising a second time offset for an FMCW-based PRS for the second cell. Means for performing the operation of block 1702 may include the processor(s) 384, memory 386, or WWAN transceiver(s) 350 of the BS 304. For example, the first base station 304 may detect a conflict between a first configuration for an FMCW-based PRS for the first cell based on messages received via the receiver(s) 352 and analyzed by the processor(s) 384.

As further shown in FIG. 17, process 1700 may include, at block 1704, modifying at least one of the first configuration or the second configuration to resolve the conflict. Means for performing the operation of block 1704 may include the processor(s) 384, memory 386, or WWAN transceiver(s) 350 of the BS 304. For example, the first base station 304 may modify at least one of the first configuration or the second configuration to resolve the conflict, using the processor(s) 384 and memory 386.

In some aspects, detecting the conflict comprises sending, to a second base station of the second cell, a first message comprising the first configuration, and receiving, from the second base station, a second message comprising a request to modify the first configuration.

In some aspects, modifying at least one of the first configuration or the second configuration to resolve the conflict comprises modifying the first configuration to resolve the conflict, and sending, to the second base station, a third message comprising the modified first configuration.

In some aspects, modifying the first configuration to resolve the conflict comprises adjusting the first time offset for the FMCW-based PRS for the first cell to be different from the second time offset for the FMCW-based PRS for the second cell.

In some aspects, detecting the conflict comprises receiving, from a second base station of the second cell, a first message comprising the second configuration for an FMCW-based PRS for a second cell, and determining that the second configuration for the FMCW-based PRS for the second cell conflicts with the first configuration for the FMCW-based PRS for the first cell.

In some aspects, determining that the second configuration for the FMCW-based PRS for the second cell conflicts with the first configuration for the FMCW-based PRS for the first cell comprises determining that the first time offset for the FMCW-based PRS for the first cell is the same as the second time offset for the FMCW-based PRS for the second cell.

In some aspects, modifying at least one of the first configuration or the second configuration to resolve the conflict comprises sending, to the second base station of the second cell, a second message comprising a request to modify the second configuration, and receiving, from the second base station of the second cell, a third message comprising a modified first configuration.

Process 1700 may include additional implementations, such as any single implementation or any combination of implementations described below and/or in connection with one or more other processes described elsewhere herein. Although FIG. 17 shows example blocks of process 1700, in some implementations, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a flowchart of an example process 1800 associated with multi-cell interference mitigation for PRS transmission with FMCW-based waveforms, according to aspects of the disclosure. In some implementations, one or more process blocks of FIG. 18 may be performed by a source base station (e.g., source base station 102). In some implementations, one or more process blocks of FIG. 18 may be performed by another device or a group of devices separate from or including the source base station. Additionally, or alternatively, one or more process blocks of FIG. 18 may be performed by one or more components of BS 304, such as processor(s) 384, memory 386, WWAN transceiver(s) 350, short-range wireless transceiver(s) 360, satellite signal receiver 370, network transceiver(s) 380, and positioning module(s) 388, any or all of which may be means for performing the operations of process 1800.

As shown in FIG. 18, process 1800 may include, at block 1802, sending, to a target base station of a target cell, a handover request comprising a request for a first configuration for an FMCW-based PRS for the target cell. Means for performing the operation of block 1802 may include the processor(s) 384, memory 386, or WWAN transceiver(s) 350 of the BS 304. For example, the source base station 304 may send the handover request via the transmitter(s) 354.

As further shown in FIG. 18, process 1800 may include, at block 1804, receiving, from the target base station, the first configuration, the first configuration comprising a first time offset for an FMCW-based PRS for the target cell. Means for performing the operation of block 1804 may include the processor(s) 384, memory 386, or WWAN transceiver(s) 350 of the BS 304. For example, the source base station 304 may receive the first configuration via the receiver(s) 352.

As further shown in FIG. 18, process 1800 may include, at block 1806, sending the first configuration to a user equipment (UE) served by the source base station. Means for performing the operation of block 1806 may include the processor(s) 384, memory 386, or WWAN transceiver(s) 350 of the BS 304. For example, the source base station 304 may send the first configuration via the transmitter(s) 354.

In some aspects, process 1800 includes performing a handover process to handover the UE to the target cell.

Process 1800 may include additional implementations, such as any single implementation or any combination of implementations described below and/or in connection with one or more other processes described elsewhere herein. Although FIG. 18 shows example blocks of process 1800, in some implementations, process 1800 may include additional blocks, fewer blocks, different blocks, or differently arranged blocks than those depicted in FIG. 18. Additionally, or alternatively, two or more of the blocks of process 1800 may be performed in parallel.

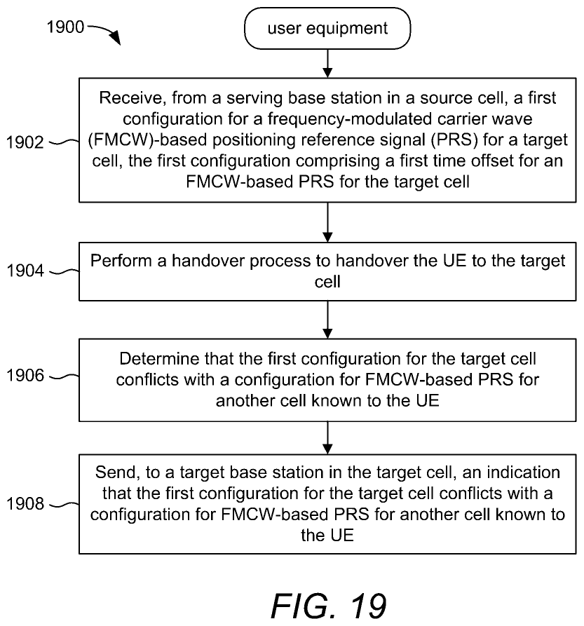

FIG. 19 is a flowchart of an example process 1900 associated with multi-cell interference mitigation for PRS transmission with FMCW-based waveforms, according to aspects of the disclosure. In some implementations, one or more process blocks of FIG. 19 may be performed by a UE (e.g., UE 104). In some implementations, one or more process blocks of FIG. 19 may be performed by another device or a group of devices separate from or including the UE. Additionally, or alternatively, one or more process blocks of FIG. 19 may be performed by one or more components of UE 302, such as processor(s) 332, memory 340, WWAN transceiver(s) 310, short-range wireless transceiver(s) 320, satellite signal receiver 330, sensor(s) 344, user interface 346, and positioning module(s) 342, any or all of which may be means for performing the operations of process 1900.

As shown in FIG. 19, process 1900 may include, at block 1902, receiving, from a serving base station in a source cell, a first configuration for a frequency modulated continuous wave (FMCW)-based positioning reference signal (PRS) for a target cell, the first configuration comprising a first time offset for an FMCW-based PRS for the target cell. Means for performing the operation of block 1902 may include the processor(s) 332, memory 340, or WWAN transceiver(s) 310 of the UE 302. For example, the UE 302 may receive the first configuration using the receiver(s) 312.

As further shown in FIG. 19, process 1900 may include, at block 1904, performing a handover process to handover the UE to the target cell. Means for performing the operation of block 1904 may include the processor(s) 332, memory 340, or WWAN transceiver(s) 310 of the UE 302. For example, the UE 302 may perform a handover process to handover the UE to the target cell, using its receiver(s) 312 and transmitter(s) 314.

As further shown in FIG. 19, process 1900 may include, at block 1906, determining that the first configuration for the target cell conflicts with a configuration for FMCW-based PRS for another cell known to the UE. Means for performing the operation of block 1906 may include the processor(s) 332, memory 340, or WWAN transceiver(s) 310 of the UE 302. For example, the UE 302 may determine that the first configuration for the target cell conflicts with a configuration for FMCW-based PRS for another cell known to the UE, using the processor(s) 332 and memory 340.

As further shown in FIG. 19, process 1900 may include, at block 1908, sending, to a target base station in the target cell, an indication that the first configuration for the target cell conflicts with a configuration for FMCW-based PRS for another cell known to the UE. Means for performing the operation of block 1908 may include the processor(s) 332, memory 340, or WWAN transceiver(s) 310 of the UE 302. For example, the UE 302 may send the indication that the first configuration for the target cell conflicts with a configuration for FMCW-based PRS for another cell known to the UE, using the transmitter(s) 314.

Process 1900 may include additional implementations, such as any single implementation or any combination of implementations described below and/or in connection with one or more other processes described elsewhere herein. Although FIG. 19 shows example blocks of process 1900, in some implementations, process 1900 may include additional blocks, fewer blocks, different blocks, or differently arranged blocks than those depicted in FIG. 19. Additionally, or alternatively, two or more of the blocks of process 1900 may be performed in parallel.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of wireless communication performed by a first base station of a first cell, the method comprising: detecting a conflict between a first configuration for a frequency modulated continuous wave (FMCW)-based positioning reference signal (PRS) for the first cell, the first configuration comprising a first time offset for an FMCW-based PRS for the first cell, and a second configuration for an FMCW-based PRS for a second cell, the second configuration comprising a second time offset for an FMCW-based PRS for the second cell; and modifying at least one of the first configuration or the second configuration to resolve the conflict.
Clause 2. The method of clause 1, wherein detecting the conflict comprises: sending, to a second base station of the second cell, a first message comprising the first configuration; and receiving, from the second base station, a second message comprising a request to modify the first configuration.
Clause 3. The method of clause 2, wherein modifying at least one of the first configuration or the second configuration to resolve the conflict comprises: modifying the first configuration to resolve the conflict; and sending, to the second base station, a third message comprising the modified first configuration.
Clause 4. The method of clause 3, wherein modifying the first configuration to resolve the conflict comprises adjusting the first time offset for the FMCW-based PRS for the first cell to be different from the second time offset for the FMCW-based PRS for the second cell.
Clause 5. The method of any of clauses 1 to 4, wherein detecting the conflict comprises: receiving, from a second base station of the second cell, a first message comprising the second configuration for an FMCW-based PRS for a second cell; and determining that the second configuration for the FMCW-based PRS for the second cell conflicts with the first configuration for the FMCW-based PRS for the first cell.
Clause 6. The method of clause 5, wherein determining that the second configuration for the FMCW-based PRS for the second cell conflicts with the first configuration for the FMCW-based PRS for the first cell comprises determining that the first time offset for the FMCW-based PRS for the first cell is the same as the second time offset for the FMCW-based PRS for the second cell.
Clause 7. The method of any of clauses 5 to 6, wherein modifying at least one of the first configuration or the second configuration to resolve the conflict comprises: sending, to the second base station of the second cell, a second message comprising a request to modify the second configuration; and receiving, from the second base station of the second cell, a third message comprising a modified first configuration.
Clause 8. A method of wireless communication performed by a source base station of a source cell, the method comprising: sending, to a target base station of a target cell, a handover request comprising a request for a first configuration for a frequency modulated continuous wave (FMCW)-based positioning reference signal (PRS) for the target cell; receiving, from the target base station, the first configuration, the first configuration comprising a first time offset for an FMCW-based PRS for the target cell; and sending the first configuration to a user equipment (UE) served by the source base station.
Clause 9. The method of clause 8, further comprising performing a handover process to handover the UE to the target cell.
Clause 10. A method of wireless communication performed by a user equipment (UE), the method comprising: receiving, from a serving base station in a source cell, a first configuration for a frequency modulated continuous wave (FMCW)-based positioning reference signal (PRS) for a target cell, the first configuration comprising a first time offset for an FMCW-based PRS for the target cell; performing a handover process to handover the UE to the target cell; determining that the first configuration for the target cell conflicts with a configuration for FMCW-based PRS for another cell known to the UE; and sending, to a target base station in the target cell, an indication that the first configuration for the target cell conflicts with a configuration for FMCW-based PRS for another cell known to the UE.
Clause 11. A first base station, comprising: a memory; at least one transceiver; and at least one processor communicatively coupled to the memory and the at least one transceiver, the at least one processor configured to: detect a conflict between a first configuration for a frequency modulated continuous wave (FMCW)-based positioning reference signal (PRS) for the first cell, the first configuration comprising a first time offset for an FMCW-based PRS for the first cell, and a second configuration for an FMCW-based PRS for a second cell, the second configuration comprising a second time offset for an FMCW-based PRS for the second cell; and modify at least one of the first configuration or the second configuration to resolve the conflict.
Clause 12. The first base station of clause 11, wherein, to detect the conflict, the at least one processor is configured to: send, to a second base station of the second cell via the at least one transceiver, a first message comprising the first configuration; and receive, from the second base station via the at least one transceiver, a second message comprising a request to modify the first configuration.
Clause 13. The first base station of clause 12, wherein, to modify at least one of the first configuration or the second configuration to resolve the conflict, the at least one processor is configured to: modify the first configuration to resolve the conflict; and send, to the second base station via the at least one transceiver, a third message comprising the modified first configuration.
Clause 14. The first base station of clause 13, wherein, to modify the first configuration to resolve the conflict, the at least one processor is configured to adjust the first time offset for the FMCW-based PRS for the first cell to be different from the second time offset for the FMCW-based PRS for the second cell.
Clause 15. The first base station of any of clauses 11 to 14, wherein, to detect the conflict, the at least one processor is configured to: receive, from a second base station of the second cell via the at least one transceiver, a first message comprising the second configuration for an FMCW-based PRS for a second cell; and determine that the second configuration for the FMCW-based PRS for the second cell conflicts with the first configuration for the FMCW-based PRS for the first cell.
Clause 16. The first base station of clause 15, wherein, to determine that the second configuration for the FMCW-based PRS for the second cell conflicts with the first configuration for the FMCW-based PRS for the first cell, the at least one processor is configured to determine that the first time offset for the FMCW-based PRS for the first cell is the same as the second time offset for the FMCW-based PRS for the second cell.
Clause 17. The first base station of any of clauses 15 to 16, wherein, to modify at least one of the first configuration or the second configuration to resolve the conflict, the at least one processor is configured to: send, to the second base station of the second cell via the at least one transceiver, a second message comprising a request to modify the second configuration; and receive, from the second base station of the second cell via the at least one transceiver, a third message comprising a modified first configuration.
Clause 18. The first base station of any of clauses 11 to 17, wherein the at least one processor is further configured to: send, to a target base station of a target cell via the at least one transceiver, a handover request comprising a request for a first configuration for a frequency modulated continuous wave (FMCW)-based positioning reference signal (PRS) for the target cell; receive, from the target base station via the at least one transceiver, the first configuration, the first configuration comprising a first time offset for an FMCW-based PRS for the target cell; and send, to a user equipment (UE) served by the source base station via the at least one transceiver, the first configuration.
Clause 19. The first base station of clause 18, wherein the at least one processor is further configured to perform a handover process to handover the UE to the target cell.
Clause 20. An apparatus comprising a memory, a transceiver, and a processor communicatively coupled to the memory and the transceiver, the memory, the transceiver, and the processor configured to perform a method according to any of clauses 1 to 10.
Clause 21. An apparatus comprising means for performing a method according to any of clauses 1 to 10.
Clause 22. A non-transitory computer-readable medium storing computer-executable instructions, the computer-executable comprising at least one instruction for causing a computer or processor to perform a method according to any of clauses 1 to 10.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of wireless communication performed by a first base station of a first cell, the method comprising:
detecting a conflict between a first configuration for a frequency modulated continuous wave (FMCW)-based positioning reference signal (PRS) for the first cell, the first configuration comprising a first time offset for an FMCW-based PRS for the first cell, and a second configuration for an FMCW-based PRS for a second cell, the second configuration comprising a second time offset for an FMCW-based PRS for the second cell; and
modifying at least one of the first configuration or the second configuration to resolve the conflict.

2. The method of claim 1, wherein detecting the conflict comprises:
sending, to a second base station of the second cell, a first message comprising the first configuration; and
receiving, from the second base station, a second message comprising a request to modify the first configuration.

3. The method of claim 2, wherein modifying at least one of the first configuration or the second configuration to resolve the conflict comprises:
modifying the first configuration to resolve the conflict; and
sending, to the second base station, a third message comprising the modified first configuration.

4. The method of claim 3, wherein modifying the first configuration to resolve the conflict comprises adjusting the first time offset for the FMCW-based PRS for the first cell to be different from the second time offset for the FMCW-based PRS for the second cell.

5. The method of claim 1, wherein detecting the conflict comprises:
receiving, from a second base station of the second cell, a first message comprising the second configuration for an FMCW-based PRS for a second cell; and
determining that the second configuration for the FMCW-based PRS for the second cell conflicts with the first configuration for the FMCW-based PRS for the first cell.

6. The method of claim 5, wherein determining that the second configuration for the FMCW-based PRS for the second cell conflicts with the first configuration for the FMCW-based PRS for the first cell comprises determining that the first time offset for the FMCW-based PRS for the first cell is the same as the second time offset for the FMCW-based PRS for the second cell.

7. The method of claim 5, wherein modifying at least one of the first configuration or the second configuration to resolve the conflict comprises:
sending, to the second base station of the second cell, a second message comprising a request to modify the second configuration; and
receiving, from the second base station of the second cell, a third message comprising a modified first configuration.

8. A method of wireless communication performed by a source base station of a source cell, the method comprising:
sending, to a target base station of a target cell, a handover request comprising a request for a first configuration for a frequency modulated continuous wave (FMCW)-based positioning reference signal (PRS) for the target cell;
receiving, from the target base station, the first configuration, the first configuration comprising a first time offset for an FMCW-based PRS for the target cell; and
sending the first configuration to a user equipment (UE) served by the source base station.

9. The method of claim 8, further comprising performing a handover process to handover the UE to the target cell.

10. A method of wireless communication performed by a user equipment (UE), the method comprising:
receiving, from a serving base station in a source cell, a first configuration for a frequency modulated continuous wave (FMCW)-based positioning reference signal (PRS) for a target cell, the first configuration comprising a first time offset for an FMCW-based PRS for the target cell;
performing a handover process to handover the UE to the target cell;
determining that the first configuration for the target cell conflicts with a configuration for FMCW-based PRS for another cell known to the UE; and
sending, to a target base station in the target cell, an indication that the first configuration for the target cell conflicts with a configuration for FMCW-based PRS for another cell known to the UE.

11. A first base station, comprising:
a memory;
at least one transceiver; and
at least one processor communicatively coupled to the memory and the at least one transceiver, the at least one processor configured to:
detect a conflict between a first configuration for a frequency modulated continuous wave (FMCW)-based positioning reference signal (PRS) for a first cell, the first configuration comprising a first time offset for an FMCW-based PRS for the first cell, and a second configuration for an FMCW-based PRS for a second cell, the second configuration comprising a second time offset for an FMCW-based PRS for the second cell; and
modify at least one of the first configuration or the second configuration to resolve the conflict.

12. The first base station of claim 11, wherein, to detect the conflict, the at least one processor is configured to:
send, to a second base station of the second cell via the at least one transceiver, a first message comprising the first configuration; and
receive, from the second base station via the at least one transceiver, a second message comprising a request to modify the first configuration.

13. The first base station of claim 12, wherein, to modify at least one of the first configuration or the second configuration to resolve the conflict, the at least one processor is configured to:
modify the first configuration to resolve the conflict; and
send, to the second base station via the at least one transceiver, a third message comprising the modified first configuration.

14. The first base station of claim 13, wherein, to modify the first configuration to resolve the conflict, the at least one processor is configured to adjust the first time offset for the FMCW-based PRS for the first cell to be different from the second time offset for the FMCW-based PRS for the second cell.

15. The first base station of claim 11, wherein, to detect the conflict, the at least one processor is configured to:
receive, from a second base station of the second cell via the at least one transceiver, a first message comprising the second configuration for an FMCW-based PRS for a second cell; and
determine that the second configuration for the FMCW-based PRS for the second cell conflicts with the first configuration for the FMCW-based PRS for the first cell.

16. The first base station of claim 15, wherein, to determine that the second configuration for the FMCW-based PRS for the second cell conflicts with the first configuration for the FMCW-based PRS for the first cell, the at least one processor is configured to determine that the first time offset for the FMCW-based PRS for the first cell is the same as the second time offset for the FMCW-based PRS for the second cell.

17. The first base station of claim 15, wherein, to modify at least one of the first configuration or the second configuration to resolve the conflict, the at least one processor is configured to:
send, to the second base station of the second cell via the at least one transceiver, a second message comprising a request to modify the second configuration; and
receive, from the second base station of the second cell via the at least one transceiver, a third message comprising a modified first configuration.

18. The first base station of claim 11, wherein the at least one processor is further configured to:
send, to a target base station of a target cell via the at least one transceiver, a handover request comprising a request for a first configuration for a frequency modulated continuous wave (FMCW)-based positioning reference signal (PRS) for the target cell;
receive, from the target base station via the at least one transceiver, the first configuration, the first configuration comprising a first time offset for an FMCW-based PRS for the target cell; and
send, to a user equipment (UE) served by the first base station via the at least one transceiver, the first configuration.

19. The first base station of claim 18, wherein the at least one processor is further configured to perform a handover process to handover the UE to the target cell.
